(19) United States
(12) Patent Application Publication
(10) Pub. No.: US 2006/0146435 A1
(43) Pub. Date: Jul. 6, 2006

(54) Data erasing device using permanent magnet

(75) Inventors: Hiroshi Hasegawa, Higashine (JP); Hisato Suzuki, Higashine (JP); Hiroyuki Uematsu, Higashine (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/128,380

(22) Filed: May 13, 2005

(30) Foreign Application Priority Data
Jan. 5, 2005 (JP) 2005-000777

(51) Int. Cl. G11B 5/03

(52) U.S. Cl. 360/66

(57) ABSTRACT

A data erasing device erasing data from a magnetic disk using horizontal-direction and vertical-direction magnetic fields of magnets consists of a main body case having a path connected to an opening formed on one side surface, a first magnetic field generating source having three permanent magnets adjacently disposed on one surface of the path in mutually adsorbing polarities, a second magnetic field generating source having three permanent magnets on the other side of the first magnetic field generating source via the path, and a tray that accommodates a magnetic recording medium and reciprocates within the path. Only one permanent magnet at one end of the second magnetic field generating source has a polarity of the same direction as that of the opposite permanent magnet. Each of the rest two permanent magnets has a polarity in a direction different from that of the opposite permanent magnet.

### CROSS-REFERENCE TO RELATED APPLICATION

This application claims priority from, and incorporates by reference the entire disclosure of, Japanese Patent Application No. 2005-000777, filed on Jan. 5, 2005, the contents being incorporated herein by reference.

### BACKGROUND OF THE INVENTION

1. Field of the Invention

The present invention relates to a data erasing device and, more particularly, to a data erasing device for a hard disk as a memory device that is used in a computer.

2. Description of the Related Art

Conventionally, in computers such as personal computers and the like, recording media for recording programs and data are necessary, and in recent years, hard disk devices using a disk coated with a magnetic material have become popular as such recording media. Such hard disk devices are built into the computer or are used as external hard disk devices connected to the computer via a cable, data being written into at least one internal disk via at least one head. The storage capacity of these types of hard disks has been steadily increasing over the years.

Meanwhile, personal computers are being sold in new formats year by year along with advances in the operating systems that drive them, the processing speed of CPUs (central processing units), the expansion of communication functions, the increase in the capacity of hard disk devices, and the like, so that there is a tendency for old personal computers to be replaced with new personal computers within a short period of time.

Hard disk devices built into old computers that have been disposed of when replaced by new computers, and hard disk devices with small memory capacities which have been disposed of when replaced by new hard disk devices with larger memory capacities, still contain large amounts of various types of data which were written into the hard disk device while it was in use. Amongst this data is data, such as personal information, internal company information and the like, that must not be leaked to a third person. In such cases it is common to perform an erasing process using computer software to erase data from the hard disk device prior to disposal.

However, this data erasing process is simply a process which allows data to be written over regions of the disks in the hard disk device in which data has been previously stored. Consequently, all of the data which had been stored on the disk is not completely erased. Thus, regarding hard disk devices from which data has not been completely erased in this manner, a malicious third person, using special software, can read the remaining data.

In this regard, as methods for completely erasing data recorded on a hard disk device, a method of writing random data on the entire surface of the magnetic disk in the hard disk devices and a method of forcefully erasing data by passing the magnetic disks of hard disk device through a powerful magnetic field such as that generated by a permanent magnet or the like, are known. With respect to the first method, the existence of software for service organizations and retailers to perform this method is well known. Also, with respect to the second method, data erasing devices for erasing data by applying a strong magnetic field to magnetic disks by controlling the strength of the magnetic field applied to the spindle motor of the hard disk device are known (for example, refer to a patent literature 1). Because the data erasing device disclosed in patent literature 1 has an object of allowing reuse the magnetic disks, data on the magnetic disk is deleted by passing one end of the magnetic disk device through a magnetic field sandwiched by permanent magnets in a state that the magnetic disk is rotated by the spindle motor.

The method of writing random data on the entire surface of the magnetic disks of the hard disk device as described above has a problem in that writing the data takes time due to the large capacity of the hard disk device, and has an additional problem in that the disposal cost increases when a service organization is asked to erase the data. On the other hand, in the data erasing device disclosed in Japanese Patent Application Unexamined Publication No. 2001-331904 for erasing data by means of magnetic saturation, by passing the magnetic disk through a strong magnetic field, equipment for rotating the spindle motor is necessary, leading to the problem of an increase in the device size. Also, there is a problem in that if, for some reason, the spindle motor does not rotate, the data will not be completely erased. As explained above, the conventional data erasing device does not take into account the erasing of data with the object of only preventing data leakage from the disposed hard disk device without reusing the magnetic disk.

The inventors of the present invention have proposed a portable and convenient data erasing device that can reliably erase data of a horizontal recording system, for preventing leakage of data recorded on a magnetic disk device or other magnetic recording medium such as a hard disk device to be destroyed, as disclosed in Japanese Patent Application Unexamined Publication No. 2004-110908.

As means for writing data on a magnetic disk, while a horizontal recording system is a main system at present, a vertical recording system will be employed in the near future to increase the recording density. It becomes necessary to erase data recorded by the vertical recording system. However, according to the data erasing device proposed previously, the magnetic field generated to erase data is only active in the horizontal direction. Therefore, a magnetic field of data on the magnetic disk written by the vertical recording system is orthogonal with the magnetic field for erasing data, and the data cannot be erased completely.

### SUMMARY OF THE INVENTION

Therefore, it is an object of the present invention to provide a data erasing device that can reliably erase data in a simple operation when data is recorded, by the horizontal recording system or by the vertical recording system, on a magnetic disk device or other magnetic recording medium such as a hard disk device to be destroyed.

The present invention that achieves the above object is disclosed as the following first to third aspects.

According to a first aspect of the present invention, there is provided a data erasing device that erases data, recorded on a magnetic recording medium, by using a magnetic field generated from permanent magnets each having an N pole and an S pole, the data erasing device including: a main body case having an opening on at least one side surface, and having a path inside the main body which is connected to the opening; a first magnetic field generating source provided along one surface of the path, and having at least three permanent magnets adjacently disposed in mutually adsorbing polarities; a second magnetic field generating source provided opposite to the first magnetic field generating source, on other surface of the path; and a tray capable of accommodating the magnetic recording medium, and having a size allowing the tray to be able to reciprocate within the main body case along the path, wherein the second magnetic field generating source consists of at least three permanent magnets that face the permanent magnets of the first magnetic field generating source, respectively, at least one set of mutually opposite permanent magnets are disposed such that magnetic field lines are generated in a direction perpendicular to the path, and the rest of the sets of permanent magnets are disposed such that magnetic field lines are generated in a direction along the path.

According to the data erasing device of the first aspect, the permanent magnets in the first magnetic field generating source and the permanent magnets in the second magnetic field generating source can be disposed on a ferromagnetic plate, respectively.

According to a second aspect of the present invention, there is provided a data erasing device that erases data, recorded on a magnetic recording medium, by using a magnetic field generated from permanent magnets each having an N pole and an S pole, the data erasing device including: a main body case for holding the magnetic recording medium on an upper surface; a first magnetic field generating source consisting of two permanent magnets adjacently disposed in mutually adsorbing polarities; a second magnetic field generating source consisting of one permanent magnet, having the same size as that of the first magnetic field generating source, and having polarities in up and down directions; a third magnetic field generating source consisting of one permanent magnet, having the same size as that of the second magnetic field generating source, and having the same polarities as those of the second magnetic field generating source; a first moving member on which the first and the second magnetic field generating sources can be mounted replaceably, and on which the mounted magnetic field generating source can be moved to a predetermined direction within the main body case; a second moving member in which the magnetic recording medium can be moved in a direction approximately orthogonal with a moving direction of the magnetic field generating source, on the upper surface of the main body case; and a holding member of the third magnetic field generating source, that is fitted to an upper part of the second moving member when the second magnetic field generating source is mounted on the first moving member, and that can have the third magnetic field generating source mounted at a position opposite to the second magnetic field generating source mounted on the first moving member.

According to a third aspect of the present invention, there is provided the data erasing device according to the second aspect: wherein the first and the second magnetic field generating sources are fitted to a ferromagnetic plate such that a generated magnetic field passes the upper surface of the main body case and reaches the upper space; the first moving member is fitted to the main body case so as to be moveable stepwise to the main body case such that the magnetic field is applied uniformly within a predetermined range on the upper surface of the main body case; the second moving member includes a frame unit capable of accommodating the magnetic recording medium at the center in a state that the magnetic recording medium is held on the upper surface of the main body case, with one end of the frame unit rotatably fixed to the upper surface of the main body case with a rotation axis; the holding member of the third magnetic field generating source has a positioning unit of the third magnetic field generating source that moves stepwise the third magnetic field generating source corresponding to the stepwise move of the first moving member; the second moving member is oscillated around the rotation axis in a state that the magnetic recording medium is accommodated in the frame unit; the position of the first moving member is sequentially changed stepwise, after the second moving member is oscillated by a predetermined number of times; and when the second magnetic field generating source is mounted on the first moving member, the third magnetic field generating source is moved with the holding member corresponding to the stepwise move of the first moving member, thereby making it possible to oscillate the second moving member by a predetermined number of times at each stage.

In the data erasing device of the third aspect, a grip that facilitates the oscillation of the frame unit is provided in projection at an end of the frame unit opposite to the end at which the rotation axis is provided, and a concavity for receiving the grip can be provided at one end of the frame constituting the holding member of the third magnetic field generating source, and a through-hole passing through the rotation axis can be provided at the other end.

The data erasing device according to the first aspect of the present invention has an effect that it is possible to erase, in a simple operation, data recorded on a magnetic recording medium such as a magnetic disk incorporated in the magnetic recording device, even when the data is recorded by the horizontal recording system or the vertical recording system. The data erasing devices according to the second and the third aspects have an effect that the size of the permanent magnet that erases data recorded on a magnetic recording medium such as a magnetic disk incorporated in the magnetic recording device can be made small, and that even when the data is recorded by the horizontal recording system or the vertical recording system, the data can be erased by replacing the permanent magnets.

### BRIEF DESCRIPTION OF THE DRAWINGS

The present invention will be more clearly understood from the description as set forth below with reference to the accompanying drawings, wherein:

FIG. 1A is an exploded perspective view of a magnetic disk device from which data is to be erased by the data erasing device according to the present invention.

FIG. 1B is a perspective view of the magnetic disk device shown in FIG. 1A in a state that the magnetic disk device is assembled.

FIG. 2A is a perspective view showing a configuration of a data erasing device according to a first embodiment of the present invention.

FIG. 2B is an explanatory diagram for explaining the principle of erasing data from a magnetic disk device by the data erasing device according to the first embodiment of the present invention.

FIG. 3A is an explanatory diagram for explaining a state that data recorded by the horizontal recording system is erased by the data erasing device according to the first embodiment of the present invention.

FIG. 3B is an explanatory diagram for explaining a state that data recorded by the vertical recording system is erased by the data erasing device according to the first embodiment of the present invention.

FIG. 4 is an exploded perspective view showing a configuration of a data erasing device according to a second embodiment of the present invention.

FIG. 5A is a perspective view of the data erasing device shown in FIG. 4 in a state that the data erasing device is assembled, a magnetic disk device recorded with data by the horizontal recording system is mounted on a swing tray, and a slide tray is fully inserted into the main body.

FIG. 5B is a perspective view of the data erasing device shown in FIG. 5A showing a state that the slide tray is extracted to a maximum extent.

FIG. 6A is an explanatory diagram for explaining the principle of erasing data recorded on the magnetic disk by the horizontal recording system, by the data erasing device according to the present invention.

FIG. 6B is a diagram for explaining a magnetic flux direction of magnets shown in FIG. 6A.

FIG. 7A is a cross-sectional view showing a state that data recorded on the magnetic disk by the horizontal recording system is erased by the data erasing device according to the present invention.

FIG. 7B is a diagram for explaining a magnetization direction of data recorded on the magnetic disk within the magnetic disk device.

FIG. 8A is a top plan view of the data erasing device shown in FIG. 5A.

FIG. 8B is a top plan view for explaining a state that the swing tray is swung to a maximum extent in the data erasing device shown in FIG. 8A.

FIG. 9A to FIG. 9D are explanatory diagram for explaining each of four steps at which the slide tray is extracted from the main body and for explaining a position of a maximum magnetic field at each step, when a magnetic disk recorded with data by the horizontal recording system is inserted in the data erasing device according to the second embodiment.

FIG. 10 is an exploded perspective view showing a configuration of the data erasing device according to the second embodiment of the present invention when the data erasing device is used to erase data recorded on a magnetic disk device by the vertical recording system.

FIG. 11A is a perspective view of the data erasing device shown in FIG. 10 in a state that the data erasing device is assembled, a magnetic disk device recorded with data by the vertical recording system and a magnetic tray are mounted on a swing tray, and a slide tray is fully inserted into the main body.

FIG. 11B is a perspective view of the data erasing device shown in FIG. 11A showing a state that the slide tray is extracted to a maximum extent.

FIG. 12A is an explanatory diagram for explaining the principle of erasing data recorded on the magnetic disk by the vertical recording system, by the data erasing device according to the present invention.

FIG. 12B is a diagram for explaining a magnetization direction of data recorded on the magnetic disk within the magnetic disk device shown in FIG. 12A.

FIG. 13A to FIG. 13D are an explanatory diagram for explaining each of four steps at which the slide tray is extracted from the main body and for explaining a position of a maximum magnetic field at each step, when a magnetic disk recorded with data by the vertical recording system is inserted in the data erasing device according to the second embodiment.

FIG. 14 is an explanatory diagram for explaining a state of a relative change between a magnetic disk and a maximum magnetic field of magnets according to the second embodiment of the present invention.

FIG. 15A is a top plan view showing a state that a magnetic disk is mounted on the swing tray of the data erasing device according to the second embodiment of the present invention.

FIG. 15B is a top plan view showing a state that a magnetic cartridge used in the library device is mounted on the swing tray of the data erasing device according to the second embodiment of the present invention.

### DESCRIPTION OF THE PREFERRED EMBODIMENTS

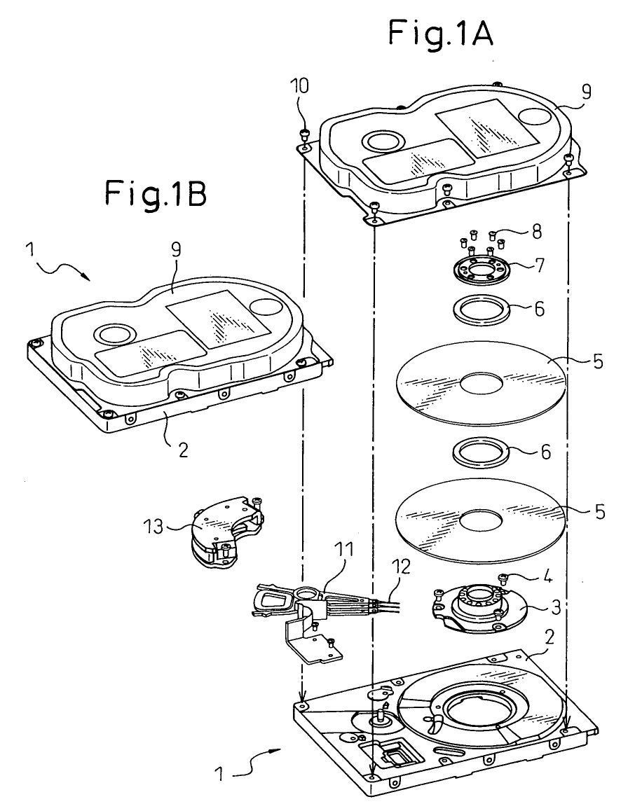

Embodiments of the present invention will be explained in detail based on concrete examples and with reference to the accompanying drawings. FIG. 1A is an exploded perspective view of a magnetic disk device 1 from which data is to be erased by the data erasing device according to the present invention. The magnetic disk device 1 is a hard disk device, and is sealed by an aluminum alloy base 2 and a cover 9. A spindle motor 3 is attached to the top of the base 2 by screws 4. At least one magnetic disk 5 is fixed to the spindle motor 3 via a clamp 7 by means of screws 8. The magnetic disks 5 are a disk-shaped recording medium for recording data, and the number of magnetic disks 5 fixed to the spindle motor 1 is determined by the specifications of the magnetic disk device 1. Spacers 6 are inserted between each of the magnetic disks 5 and between the magnetic disks 5 and the clamp 7.

Also, among the components in proximity with the magnetic disk 5 above the base 2, an actuator 11 is slidably attached. At the tip of the actuator 11, a head portion 12 comprising heads for writing data into the magnetic disks 5 or reading data from the magnetic disks 5 is provided. Also, the end portion of the actuator 11 at the opposite side of the head portion 12 is driven by a voice coil motor (VCM) 13 similarly fixed to the base 2. After the components described above are attached to the top of the base 2, the cover 9 is fixed to the base 2 with screws 10, thereby obtaining a state shown in FIG. 1B.

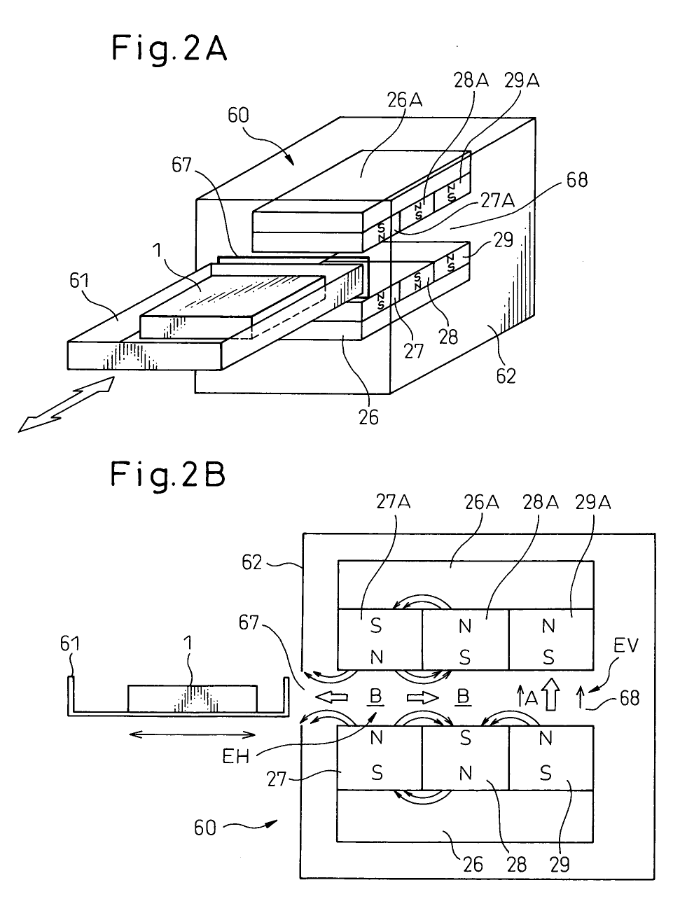

FIG. 2A shows a configuration of a data erasing device 60 according to a first embodiment of the present invention. FIG. 2B is a diagram for explaining the principle of erasing data from the magnetic disk device 1 by the data erasing device 60. An opening 67 is provided on one side surface of the data erasing device 60 according to the first embodiment. A main body case 62 having a path 68 continuing to the opening 67 is provided inside the device. A magnetic field generating source is provided in up and down directions of the path 68 within the main body case 62.

Three magnets 27, 28, and 29 are disposed on a yoke 26 structured by a ferromagnetic plate, on a lower surface of the path 68. The top surfaces of the three magnets 27, 28, and 29 form the same one plane of the path 68. The sizes of the three magnets 27, 28, and 29 are substantially the same. According to the present embodiment, the three magnets 27, 28, and 29 are adjacently disposed in mutually adsorbing polarities. In other words, the magnet 27 nearest to the opening 67 of the path 68 has polarities of an N pole at the path 68 side and an S pole at the yoke 26 side. The magnet 28 in the middle 28 has polarities of an S pole at the path 68 side and an N pole at the yoke 26 side. The magnet 29 furthest from the opening 67 has polarities of an N pole at the path 68 side and an S pole at the yoke 26 side.

Three magnets 27A, 28A, and 29A are disposed on a yoke 26A structured by a ferromagnetic plate, on an upper surface of the path 68. The top surfaces of the three magnets 27A, 28A, and 29A form the same one plane of the path 68. The widths of the three magnets 27A, 28A, and 29A are substantially the same, and are larger than the width of the magnetic disk device 1. According to the present embodiment, among the three magnets 27A, 28A, and 29A, the magnets 27A and 28A at the opening 67 side are adjacently disposed in mutually adsorbing polarities. The magnet 29A furthest from the opening 67 has polarities mutually repelling the polarities of the adjacent magnet 28A. In other words, the magnet 27A nearest to the opening 67 of the path 68 has polarities of an N pole at the path 68 side and an S pole at the yoke 26A side. The magnet 28A in the middle 28 has polarities of an S pole at the path 68 side and an N pole at the yoke 26A side. The magnet 29A furthest from the opening 67 has polarities of an S pole at the path 68 side and an N pole at the yoke 26A side.

The data erasing device 60 according to the first embodiment has a drawing type tray 61 that can be freely inserted into and drawn out from the main body case 62, in addition to the main body case 62 having the above structure. The magnetic disk device 1 as a magnetic recording medium from which data is to be erased is inserted into and drawn out from the case 62 mounted on this tray 61.

Based on the magnets 27, 28, and 29 disposed to face the path 68 within the case 62, and the magnets 27A, 28A, and 29A disposed to face these magnets respectively, magnetic fields indicated by symbols A and B are generated on the path 68, as shown in FIG. 2B. The magnetic field indicated by the symbol A consists of a magnetic flux that is directed from the magnet 29 toward the magnet 29A, and is a magnetic field in a direction perpendicular to a longitudinal direction of the path 68. On the other hand, the magnetic field indicated by the symbol B consists of a magnetic flux directed from the magnet 27 toward the magnet 28, a magnetic flux directed from the magnet 27A toward the magnet 28A, and a magnetic flux directed from the magnet 29 toward the magnet 28. These magnetic fluxes have components substantially in parallel with the longitudinal direction of the path 68.

Because the magnets 27 and 28 and the opposite magnets 27A and 28A are disposed at the front surface side of the case 26, when the tray 61 on which the magnetic disk device 1 incorporating a magnetic disk recorded with data by the horizontal recording system is inserted into and drawn out at least one time from the magnetic field B generated by the magnets 27, 28, 27A, and 28A in the case 62, the data recorded on the magnetic disk 5 within the magnetic disk device 1 is erased by this magnetic field B. In other words, the area formed by this magnetic field B is a data erasing area EH where the data recorded on the magnetic disk by the horizontal recording system is erased.

On the other hand, because the magnet 29 and the opposite magnet 29A are disposed at the back (at the back surface side) of the case 62, when the tray 61 mounted with the magnetic disk device 1 incorporating a magnetic disk recorded with data by the vertical recording system is inserted into the magnetic field A generated by the magnets 29 and 29A at the back of the case 62, the data recorded on the magnetic disk 5 by the vertical recording system within the magnetic disk device 1 is erased by this magnetic field A. In other words, the area formed by this magnetic field A is a data erasing area EV where the data recorded on the magnetic disk by the vertical recording system is erased. The positions of the data erasing areas EH and EV can be reversed with respect to the path 68. In other words, the set of the magnet 29 and the magnet 29A opposite to each other by sandwiching the path 68 can be at the left side (the opening 67 side) of the set of the magnet 27 and the magnet 27A opposite to each other by sandwiching the path 68.

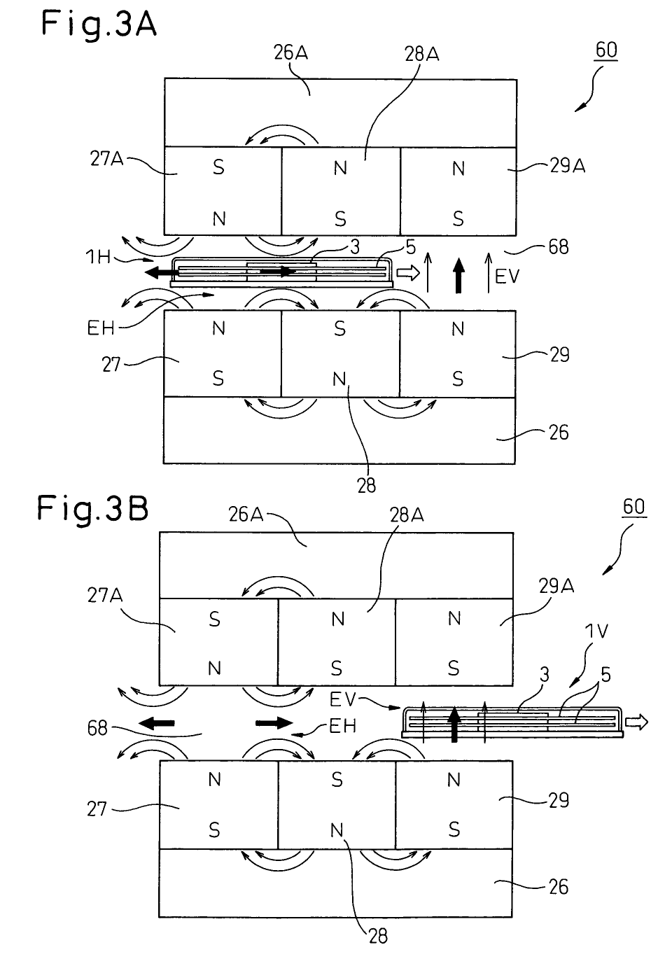

FIG. 3A shows a state that a magnetic disk device 1H onto which data is written by the horizontal recording system is inserted into the data erasing device 60 according to the first embodiment having the configuration as shown in FIG. 2. In FIG. 3A, a black arrowhead indicates a direction of a magnetic field, and an outline arrowhead indicates a moving direction of the disk device 1H. The magnetic disk device 1H onto which data is written by the horizontal recording system is passed through the data erasing area EH formed by the repulsive force of the magnets 27, 27A, 28, and 28A, by a predetermined number of times. Then, the magnetic disk 5 fitted to the spindle motor 3 of the magnetic disk device 1H passes through the magnetic field of the horizontal direction component in the data erasing area EH, so that the data written by the horizontal recording system is erased.

FIG. 3B shows a state that a magnetic disk device 1V onto which data is written by the vertical recording system is inserted into the data erasing device 60 according to the first embodiment having the configuration as shown in FIG. 2. In FIG. 3B, a black arrowhead indicates a direction of a magnetic field, and an outline arrowhead indicates a moving direction of the disk device 1V. The magnetic disk device 1V onto which data is written by the vertical recording system is passed through the data erasing area EV, formed by the adsorptive force of the magnets 29 and 29A, a predetermined number of times. Then, the magnetic disk 5 fitted to the spindle motor 3 of the magnetic disk device 1V passes through the magnetic field of the vertical direction component in the data erasing area EV, so that the data written by the vertical recording system is erased. As described above, the data erasing device 60 according to the first embodiment has a main characteristic in that, based on the design of the layout of the magnets, the data erasing device 60 can erase data that is recorded on a magnetic disk by any one of the vertical and the horizontal recording system. This is the largest strength of the device and is not present in the conventional data erasing device.

According to the data erasing device 60 of the first embodiment, when the magnetic disk device 1H onto which data is written by the horizontal recording system moves in the magnetic field formed in the horizontal direction by the magnets 27, 27A, 28, and 28A on the path 68, the magnetic field in the horizontal direction is present above and below the magnetic disk device 1H. Therefore, the same move operation of the magnetic disk device 1H mounted on the tray 61 shown in FIG. 2 does not need to be carried out repeatedly by reversing the upside of the magnetic disk device 1H to the downside. When the magnetic disk device 1V onto which data is written by the vertical recording system moves in the magnetic field formed in the vertical direction by the magnets 29 and 29A on the path 68, the magnetic field in the vertical direction passes through the magnetic disk device 1V. Therefore, the same move operation of the magnetic disk device 1V mounted on the tray 61 shown in FIG. 2 does not need to be carried out repeatedly by reversing the upside of the magnetic disk device 1H to the downside.

According to the data erasing device 60 of the first embodiment, the magnetic disk device 1H or 1V mounted on the tray 61 shown in FIG. 2 needs to be moved reciprocally on the path 68 by inserting the magnetic disk device into the path from the opening 67. On the other hand, the inventors of the present invention have proposed a data erasing device having a moving mechanism capable of reciprocally moving the magnetic disk device written with data by the horizontal recording system mounted on the tray, within the data erasing device incorporating a data erasing area having a magnetic field of the horizontal direction component, in Japanese Patent Application Unexamined Publication No. 2003-208087. The data erasing device 60 according to the first embodiment can be applied to the data erasing device proposed in Japanese Patent Application Unexamined Publication No. 2003-208087. In this case, the layout of the magnets within the data erasing device proposed in Japanese Patent Application Unexamined Publication No. 2003-208087 can be set the same as that of the data erasing device 60 according to the first embodiment.

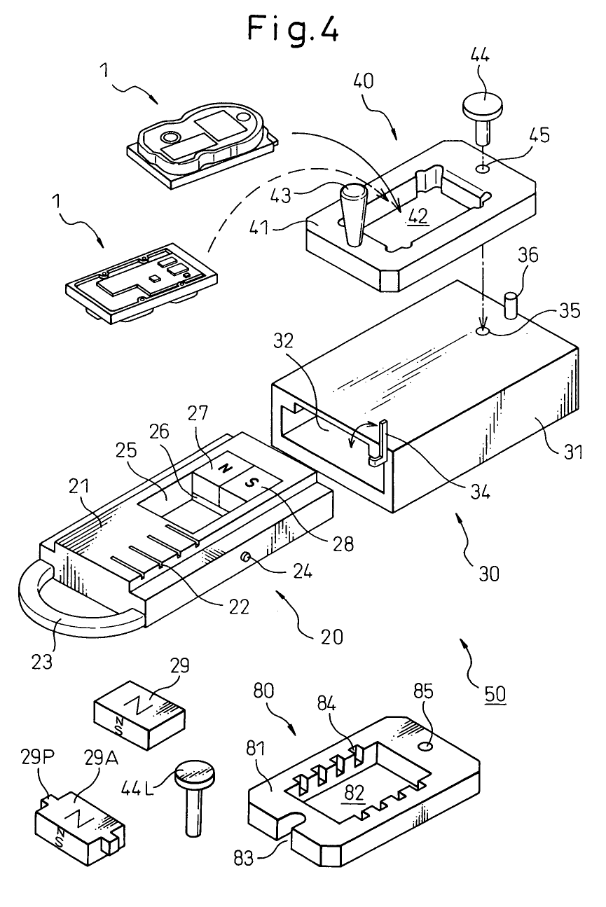

FIG. 4 is an exploded perspective view showing a configuration of a data erasing device 50 according to a second embodiment of the present invention. The data erasing device 50 according to the second embodiment broadly consists of a slide tray 20 as a first moving member, a main body 30, a swing tray 40 as a second moving member, and a magnet tray 80 as a holding member of a magnetic field generating source. The left side of the data erasing device 50 shown in the drawing is the front end of the device, and the right side is the back end of the device. Therefore, in the second embodiment, the left sides of the slide tray 20, the main body 30, the swing tray 40, and the magnet tray 80 respectively in FIG. 4 are the front end sides, and right sides of these units are the back end sides of the units respectively.

The slide tray 20 is configured to be able to slide on the main body 30. Therefore, the cross-sectional shape of the slide tray 20 in a direction orthogonal with the slide direction of the main body 21 is uniform. A knob 23 for sliding the swing tray 20 is provided at the front end of the main body 21. Grooves 22 for prescribing a stepwise slide position of the slide tray 20 to be described later are provided on the upper surface of the main body 21 at the front end at the knob 23 side. According to the second embodiment, the number of the grooves 22 is four. A magnet fitting hole 25 is provided at a backend side of the main body 21 adjacent to the grooves 22. Two permanent magnets (a first magnetic field generating source, hereinafter simply called magnets) 27 and 28 that are fitted to the yoke 26 are provided at the back end side of the magnet fitting hole 25. A stopper protrusion 24 to be described later is provided on the side surface of the main body 21.

The magnets 27 and 28 fitted to the slide tray 20 can be separated from the yoke 26, and can be replaced with other magnet 29 (a second magnetic field generating source) having the same size as a combined size of the magnets 27 and 28 and the yoke 26. The magnet 29 has an N pole on the upper side, and has an S pole on the lower side.

The main body 30 is structured by a box case 31. A concavity 32 is provided at the front end surface of the case 31 to receive the slide tray 20. The cross-sectional shape of the concavity 32 is the same as the cross-sectional shape of the base 21 of the slide tray 20. According to the present embodiment, the cross-sectional shape of the concavity 32 is a convex shape. A latch lever 34 is rotatably provided at a predetermined position of the front end surface of the case 31. The front end of the latch lever 34 is engaged with the grooves 22 of the slide tray 20. A fitting hole 35, to fit the swing tray 40, is formed on the upper surface of the case 31. A stopper 36 is provided in protrusion on the upper surface at the end of the case 31. This stopper 36 is used to restrict the swing range of the swing tray 40.

Because the stopper protrusion 24 is provided on the side surface of the slide tray 20, when the cross-sectional shape of the concavity 32 is the same as the cross-sectional shape of the base 21 of the slide tray 20, the slide tray 20 cannot be inserted into the case 31 from the front end surface side. Therefore, the case 31 of the main body 30 is of an assembly type. To embed the slide tray 20 in the concavity 32, the side surface of the case 31 is extracted at first. After the slide tray 20 is accommodated into the case 31, the extracted side surface is assembled.

The swing tray 40 has a rectangular frame 41 having a medium accommodation hole 42 provided at the center. A grip 43 is provided in protrusion on the upper surface at the front end side of the frame 41. At the back end side of the frame 41, there is provided a fitting hole 45 as a through-hole for rotatably fitting the frame 41 on the upper surface of the main body 30 with an axle pin 44. The magnetic disk device 1 shown in FIG. 1 is set in a standing state, or a laid-down state, in the medium accommodation hole 42. The swing tray 40 rotates around the axle pin 44 with an external force applied to the grip 43. The stopper 36 provided in protrusion on the upper surface of the case 31 of the main body 30 is used to restrict the swing range of the swing tray 40.

The magnet tray 80 is used to hold the magnet 29A as a third magnetic field generating source, when the magnet 29 is fitted to the slide tray 20. According to the present embodiment, the external shape of the frame 81 of the magnet tray 80 coincides with the external shape of the swing tray 40. The frame 81 has a rectangular shape and has a magnet accommodation hole 82 for accommodating the magnet 29A provided at the center. A grip accommodation groove 83 for accommodating the grip 43 when mounted on the frame 41 is provided at the front end of the frame 81. A through-hole 85 that is superimposed with the fitting hole 45 provided on the frame 41 when superimposed with the frame 41 is provided at the back end of the frame 81. To fit the frame 81 to the frame 41 by superimposing the frame 81 on the frame 41, a long axle pin 44L having a larger axial length than that of the axle pin 44 by the thickness of the frame 81 is used in place of the axle pin 44.

The magnet 29A as the third magnetic field generating source accommodated in the magnet accommodation hole 82 of the magnet tray 80 has the same shape and the same polarities as those of the magnet 29, except projections 29P provided at both ends of the magnet 29A. On the other hand, positioning grooves 84 for receiving and positioning the projections 29A provided on the magnet 29A are provided in the magnet accommodation hole 82 of the magnet tray 80. The number of the positioning grooves 84 is four and is the same as the number of the grooves 22 provided on the side surface of the slide tray 20. The interval between the position grooves 84 is the same as the interval between the grooves 22.

The slide tray 20 fitted with the magnet 29 is inserted into the concavity 32 provided on the box case 31 of the main body 30, and is pressed to the end, with the first front end groove 22 of the slide tray 20 latched with the latch lever 34. Then, the magnet tray 80 is fitted to the swing tray 41, and the projections 29P of the magnet 29A are engaged with the positioning groove 84 nearest to the through-hole 85. As a result, the magnet 29A is positioned above the magnet 29 within the main body 30.

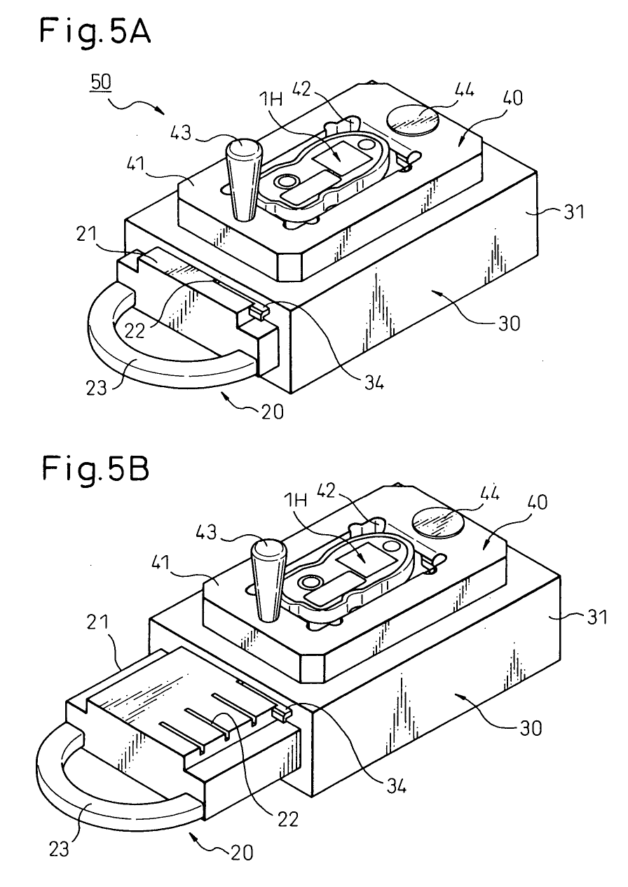

The erasing of data recorded on the magnetic disk device 1H by the horizontal recording system, with the data erasing device 50 according to the second embodiment having the above configuration is explained with reference to FIG. 5 to FIG. 9 and FIG. 14. In this case, as shown in FIG. 4, the magnets 27 and 28 are fitted to the slide tray 20, only the swing tray 40 is fitted to the supper surface of the case 31 with the axle pin 44, and the magnetic disk device 1H or the like are mounted on the medium accommodation hole 42. The magnet tray 80, the magnets 29 and 29A, and the long axle pin 44L are not used in this case.

FIG. 5A shows a state that the data erasing device 50 shown in FIG. 4 is assembled, and the slide tray 20 is fully inserted into the main body 32. In this state, the first front end groove 22 provided on the upper surface of the base 21 of the slide tray 20 is exposed from the case 31. When the latch lever 34 is rotated and is engaged with this groove 22, the slide tray 20 is fixed to the main body 30 in a state that the slide tray 20 is fully inserted into the main body 30.

FIG. 5B shows a state the slide tray 20 shown in FIG. 5A is extracted from the main body 30 to a maximum extent. In this state, all of the four grooves 22 provided on the upper surface of the base 21 of the slide tray 20 are exposed from the case 31. Therefore, when the latch lever 34 is rotated and is engaged with the backmost groove 22, the slide tray 20 is fixed to the main body 30 in a state that the slide tray 20 is fully drawn out the main body 30. The slide tray 20 can be drawn out from the main body 30 at the four stages, between the state shown in FIG. 5A and the state shown in FIG. 5B.

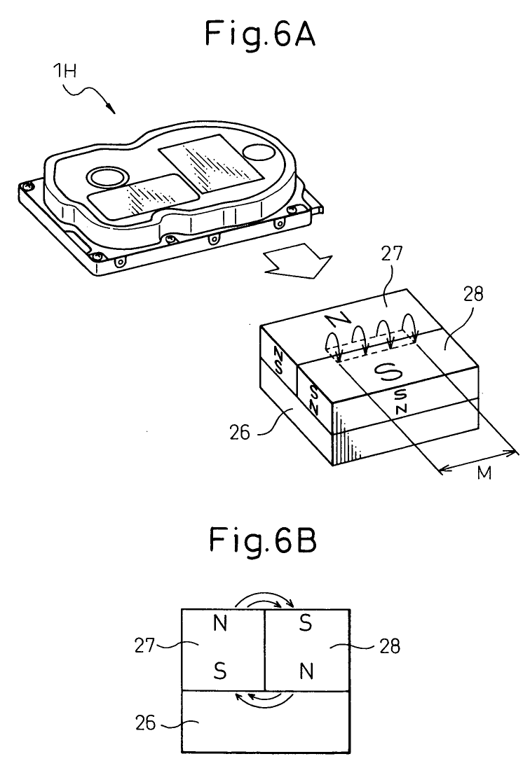

FIG. 6A explains the principle of erasing data recorded on the magnetic disk device 1H by the horizontal recording system, by the data erasing device 50 according to the present invention. FIG. 6B explains a magnetic flux direction of the magnets 27 and 28 shown in FIG. 6A. According to the present invention, on the yoke 26, the magnet 27 is disposed such that the upper side is an N pole and the lower side is an S pole, and the magnet 28 is disposed such that the upper side is an S pole and the lower side is an N pole. In other words, the magnets 27 and 28 are adjacently disposed such that the magnets have mutually adsorbing polarities, and the magnets 27 and 28 function as magnetic field generating means. When the magnets 27 and 28 are looked at as magnetic field generating means, mutually different polarities are adjacent on the front and back surfaces.

The magnetic flux generated from the N pole of the magnet 27 returns to the S pole of the magnet 28 via the external space, when the yoke 26 is not present. On the other hand, when the yoke 26 is fitted beneath the magnets 27 and 28, the magnetic flux generated from the N pole of the magnet 28 returns to the S pole of the magnet 27 via the yoke 26 without leaking to the external space. The function of the yoke 26 is to improve the magnetic flux density (mirror effect) at the side where the yoke 26 is not provided, and to restrict the unnecessary leakage of the magnetic flux to the external space at the side where the yoke 26 is provided. When the magnets 27 and 28 are disposed on the yoke 26 as described above, it is known that the magnetic flux that returns from the magnet 27 to the magnet 28 via the external space has the largest intensity at the center M where the magnet 27 and the magnet 28 are adjacent to each other as indicated by an arrowhead in FIG. 6A. This part is described as the magnetic flux maximum area M. The yoke 26 can be configured by assembling divided members, instead of an integrated unit.

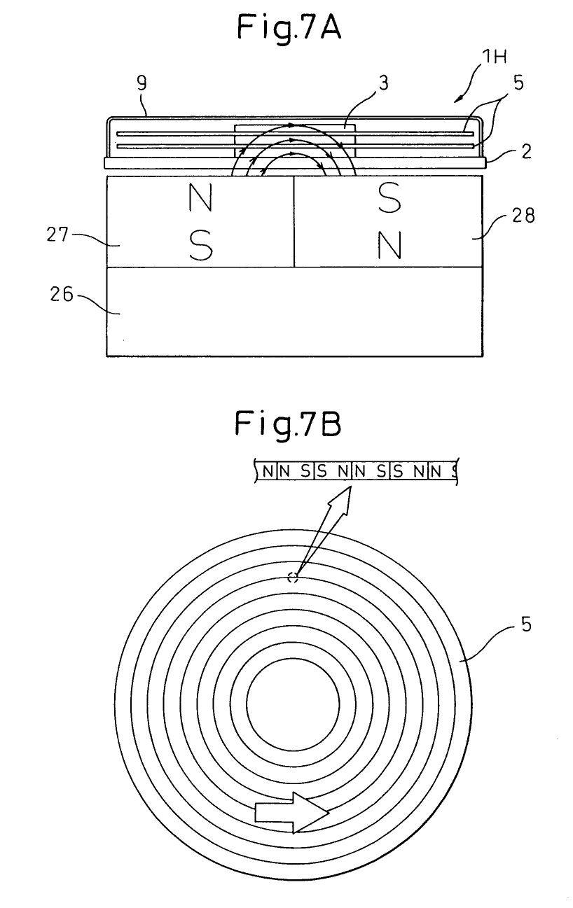

On the other hand, because the data stored on the magnetic disk 5 is based on the horizontal magnetic recording system as shown in FIG. 7B, it is preferable that a magnetic field in a direction parallel to the magnetic disk 5 is used to erase the data recorded on the magnetic disk 5. Therefore, as shown in FIG. 7A, according to the present invention, in order to erase data recorded on the magnetic disk 5 fitted to the spindle motor 3 of the magnetic disk device 1H, the magnetic disk device 1 is disposed on the magnets 27 and 28, and both are moved in the forward and backward directions (Y direction) and the left and right directions (X direction) from each other. With this arrangement, the data recorded on the magnetic disk 5 can be erased using the component in the horizontal direction of the magnetic field area generated by the magnets 27 and 28.

In order to erase data recorded on the magnetic disk 5, the intensity of the magnetic field needs to be larger than the coercive force of the magnetic disk 5. Therefore, in order to reliably erase data recorded on the magnetic disk 5 of high coercive force, it is preferable that magnets of the Nd—Fe—B system having high magnetic flux density are used for the magnets 27 and 28. On the other hand, it is preferable to restrict the unnecessary leakage of the magnetic flux from the yoke 26 of the magnets 27 and 28 to the external space. Consequently, a ferromagnetic material, such as JIS SS400, is preferably used for the material of the yoke 26.

It is also preferable that the magnetic flux maximum area M of the magnet 27 and the magnet 28 is structured to reliably pass through the data to be erased from the magnetic disk 5. When plural magnetic disks 5 are present in the magnetic disk device 1H as shown in FIG. 7A, data recorded on the magnetic disk 5 furthest from the magnets 27 and 28 cannot be erased easily. In this case, the magnetic disk device 1H is turned upside down, and the data erase operation is carried out again. With this arrangement, data recorded on the magnetic disk 5 can be reliably erased.

According to the present invention, as explained above, the magnetic field obtained based on the layout of the magnets 27 and 28 is used to erase data stored by the horizontal recording system in the magnetic disk 5 provided within the cover 9 of the magnetic disk device 1H shown in FIG. 1. In this case, in order to bring the magnetic field into contact with the whole surface of the magnetic disk 5, the sizes of the magnets 27 and 28 are increased. However, when the sizes of the magnets 27 and 28 are increased to bring the magnetic field into contact with the whole surface of the magnetic disk 5, the weight of the magnets 27 and 28 becomes very large, and it becomes difficult to carry these magnets. Further, the cost of the magnets 27 and 28 increases. In order to bring the limited magnetic field into contact with the whole surface of the magnetic disk 5, the magnetic disk 5 can be rotated with the spindle motor 3. However, when the motor fails to rotate, data recorded on the magnetic disk 5 cannot be erased completely. Therefore, this method has a problem in safety.

In the data erasing device 50 according to the second embodiment of the present invention, the sizes of the magnets 27 and 28 are made as small as possible as explained with reference to FIG. 4 and FIG. 5. At the same time, relative movement is generated between the magnets 27 and 28 and the magnetic disk 5 so that the magnetic field from the magnets 27 and 28 is brought into contact with the whole surface of the magnetic disk 5. In other words, the magnets 27 and 28 are moved in the forward and backward directions (Y direction) on the data erasing device 50 with the slide tray 20, and the magnetic disk 5 is moved in approximately the left and right directions (X direction) from the magnets 27 and 28 with the swing tray 40, thereby bringing the magnetic field into contact with the whole surface of the magnetic disk 5.

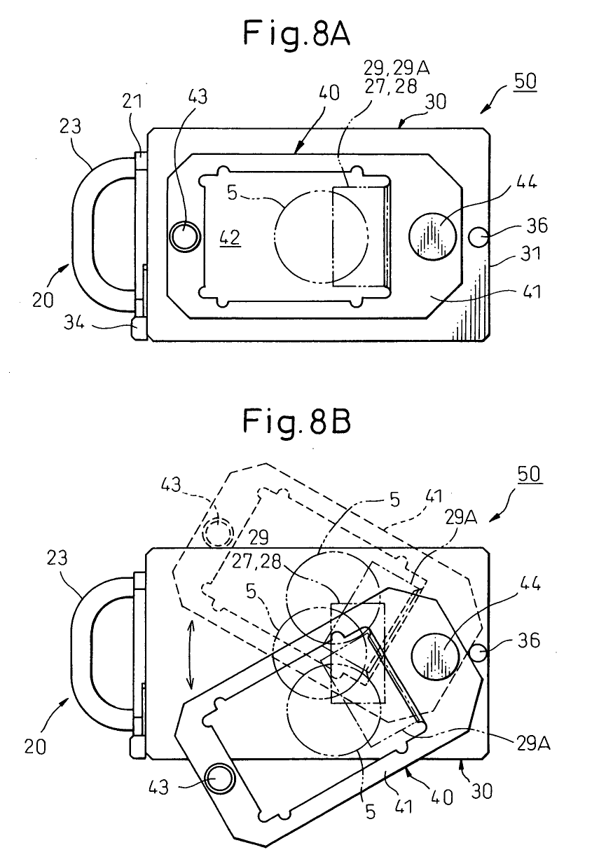

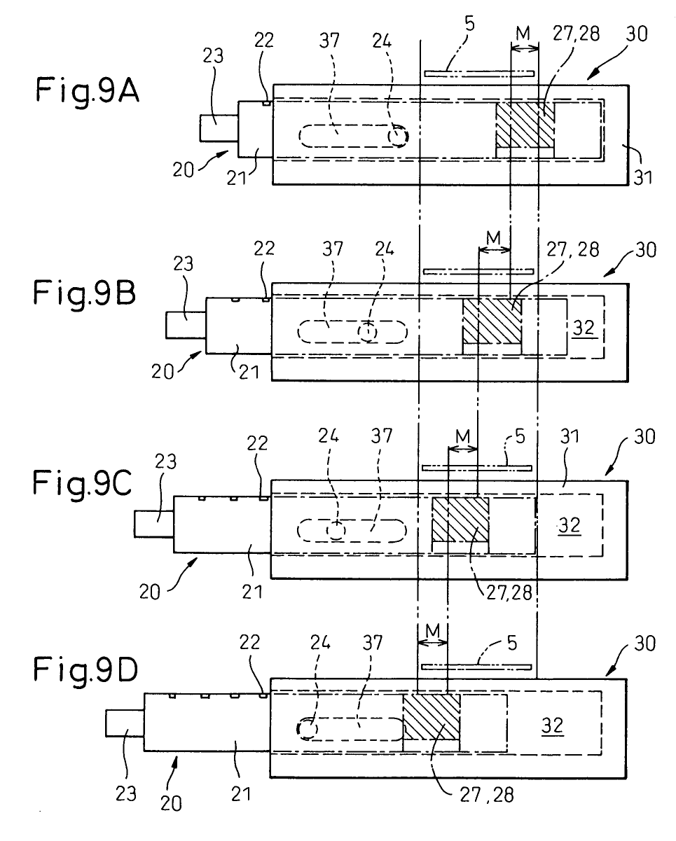

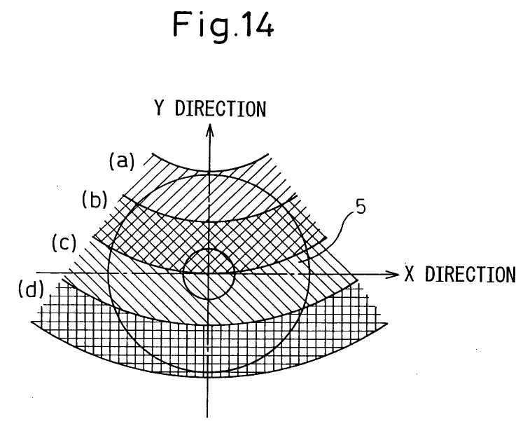

A method of completely erasing data recorded by the horizontal recording system on the magnetic disk 5 within the magnetic disk device 1H, with the data erasing device 50 according to the second embodiment of the present invention is explained with reference to FIG. 8, FIG. 9, and FIG. 14.

FIG. 8A is a top plan view of the data erasing device 50 in a state shown in FIG. 5A. This shows a relationship between the positions of the magnets 27 and 28 accommodated in the slide tray 20 and the position of the magnetic disk 5 within the magnetic disk device 1 when the magnetic disk device 1 is fitted to the swing tray 40. FIG. 9A shows a state that the data erasing device 50 shown in FIG. 8A is looked at from the side surface. According to the second embodiment, as shown in FIG. 9A, the magnets 27 and 28 are disposed in the slide tray 20 so that the magnetic flux maximum area M of the magnets 27 and 28 is within the range of a quarter of the diameter of the magnetic disk 5 from the rear end of the magnetic disk 5 within the magnetic disk device 1 fitted to the swing tray 40. In this case, the stopper protrusion 24 provided on the side surface of the slide tray 20 is at a position where the stopper protrusion 24 is in contact with the rear end of the guide groove 37 formed inside the case 31 of the main body 30.

In this state, when the swing tray 40 is swung from the position of a solid line to the position of a broken line by grasping the grip 43 as shown in FIG. 8A, the magnetic disk 5 moves in approximately the left and right directions above the magnets 27 and 28 as shown by a chain double-dashed line. A relative moving area of the magnets 27 and 28 observed from the magnetic disk 5 is shown as an area (a) in FIG. 14. As is clear from FIG. 14, when the swing tray 40 is swung in the state shown in FIG. 9A, the magnets 27 and 28 can erase the data recorded in the area (a) of the magnetic disk 5 corresponding to one quarter of the diameter of the magnetic disk 5.

Next, in the state shown in FIG. 9A, the latch lever 34 (refer to FIG. 4 and FIG. 5) is extracted and the knob 23 is pulled, so that the slide tray 20 is drawn out from the case 31 to a distance where the second groove 22 is exposed from the case 31, thereby obtaining a state shown in FIG. 9B. Then, the slide tray 20 is fixed with the latch lever 34. In this state, the magnetic flux maximum area M of the magnets 27 and 28 is positioned within a range of one quarter of the diameter of the magnetic disk 5 from the center of the magnetic disk 5 toward the rear end of the magnetic disk 5 within the magnetic disk device 1H fitted to the swing tray 40.

In this state, the grip 43 is grasped and the swing tray 40 is oscillated as described above. A relative moving area of the magnets 27 and 28 observed from the magnetic disk 5 is shown as an area (b) in FIG. 14. As is clear from FIG. 14, when the swing tray 40 is swung in the state shown in FIG. 9B, the magnets 27 and 28 can erase the data recorded in the area (b) of the magnetic disk 5 corresponding to one quarter of the diameter of the magnetic disk 5, adjacent to the data area of the magnetic disk 5 erased by oscillating the swing tray 40 in the state shown in FIG. 9A.

Next, in the state shown in FIG. 9B, the latch lever 34 (refer to FIG. 4 and FIG. 5) is extracted and the knob 23 is pulled, so that the slide tray 20 is drawn out from the case 31 to a distance where the third groove 22 is exposed from the case 31, thereby obtaining a state shown in FIG. 9C. Then, the slide tray 20 is fixed with the latch lever 34. In this state, the magnetic flux maximum area M of the magnets 27 and 28 is positioned within a range of one quarter of the diameter of the magnetic disk 5 from the center of the magnetic disk 5 toward the front end of the magnetic disk 5 within the magnetic disk device 1H fitted to the swing tray 40.

In this state, the grip 43 is grasped and the swing tray 40 is oscillated as described above. A relative moving area of the magnets 27 and 28 observed from the magnetic disk 5 is shown as an area (c) in FIG. 14. As is clear from FIG. 14, when the swing tray 40 is swung in the state shown in FIG. 9C, the magnets 27 and 28 can erase the data recorded in the area (c) of the magnetic disk 5 corresponding to one quarter of the diameter of the magnetic disk 5, adjacent to the data area of the magnetic disk 5 erased by oscillating the swing tray 40 in the state shown in FIG. 9B.

Last, in the state shown in FIG. 9C, the latch lever 34 (refer to FIG. 4 and FIG. 5) is extracted, and the knob 23 is pulled, so that the stopper protrusion 24 provided on the side surface of the slide tray 20 is brought into contact with the rear end of the guide groove 37 formed inside the case 31 of the main body 30. Then, the fourth groove 22 is exposed from the case 31, and the slide tray 20 is fixed with the latch lever 34. In this state, the magnetic flux maximum area M of the magnets 27 and 28 is positioned within a range of one quarter of the diameter of the magnetic disk 5 from the front end of the magnetic disk 5 within the magnetic disk device 1H fitted to the swing tray 40.

In this state, the grip 43 is grasped and the swing tray 40 is oscillated as described above. A relative moving area of the magnets 27 and 28 observed from the magnetic disk 5 is shown as an area (d) in FIG. 14. As is clear from FIG. 14, when the swing tray 40 is swung in the state shown in FIG. 9D, the magnets 27 and 28 can erase the data recorded in the area (d) of the magnetic disk 5 corresponding to one quarter of the diameter of the magnetic disk 5, adjacent to the data area of the magnetic disk 5 erased by oscillating the swing tray 40 in the state shown in FIG. 9C.

As described above, the slide tray 20 is drawn out at four stages from the case 31 of the main body 30, and the slide tray 40 is oscillated at each stage. With this arrangement, data recorded on the whole surface of the magnetic disk 5 can be erased with the magnets 27 and 28 having small sizes of about a quarter of the size of the magnetic disk 5. Afterward, when the magnetic disk device 1H set to the swing tray 40 is placed upside down, and the above operation is carried out in the opposite order by inserting the slide tray 20 into the main body 30, the data recorded on the magnetic disk 5 within the magnetic disk device 1 can be erased more completely.

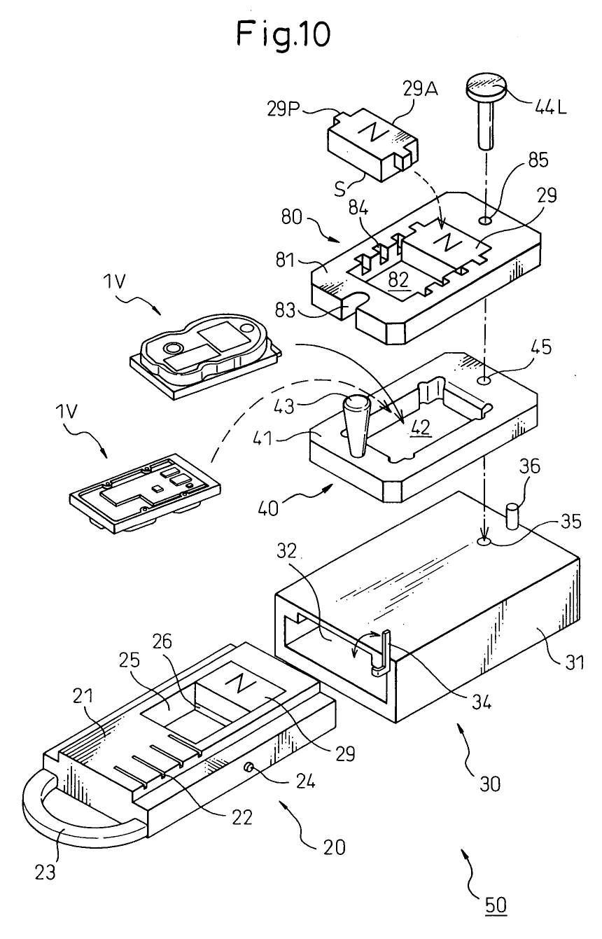

A method of erasing data recorded by the vertical recording system on the magnetic disk within the magnetic disk device, with the data erasing device 50 according to the second embodiment is explained with reference to FIG. 10 to FIG. 14. In this case, as shown in FIG. 10, the magnet 29 is fitted to the slide tray 20. The swing tray 40 with the magnetic disk device 1V or the like mounted on the medium accommodation hole 42 is disposed on the upper surface of the case 31 such that the fitting hole 45 is superimposed on the fitting hole 35 of the case 31. The magnet tray 80 having the magnet 29A fitted to the most rear position is mounted on the swing tray 40 in a state that the grip accommodation groove 83 is engaged with the grip 43. The through-hole 85 is matched with the fitting hole 45 of the swing tray 40, and the long pin 44L is pierced through these holes.

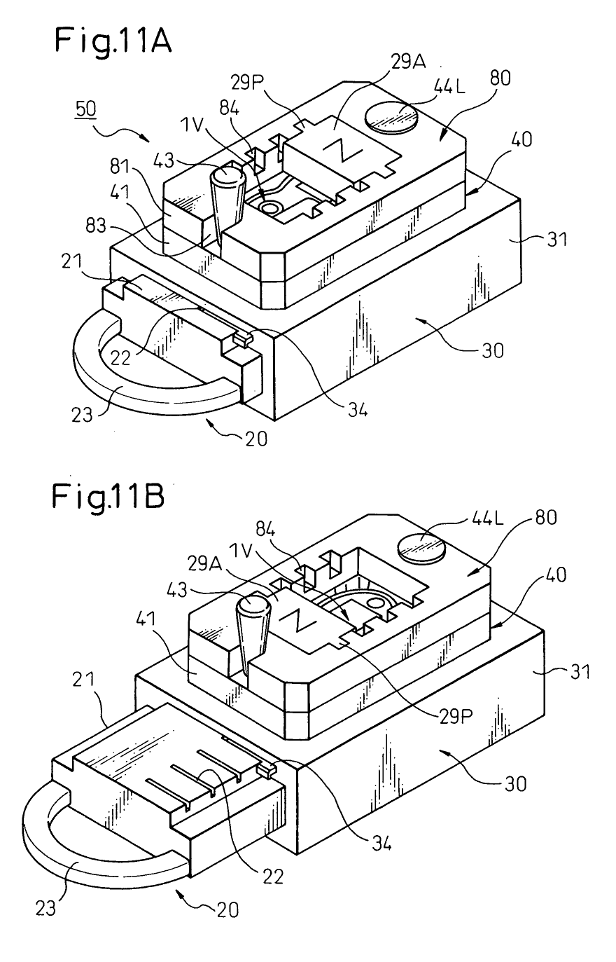

FIG. 11A shows a state that the data erasing device 50 shown in FIG. 10 is assembled, and the slide tray 20 is fully inserted into the main body 30. In this state, the most front end groove 22 provided on the upper surface of the base 21 of the slide tray 20 is exposed from the case 31. When the latch lever 34 is rotated to be engaged with this groove 22, the slide tray 20 is fixed to the main body 30 in a state that the slide tray 20 is fully inserted into the main body 30.

FIG. 11B shows a state that the slide tray 20 shown in FIG. 11A is extracted to a maximum extent from the main body 30. In this state, all of the four grooves 22 provided on the upper surface of the base 21 of the slide tray 20 are exposed from the case 31. Therefore, when the latch lever 34 is rotated to be engaged with the most rear end groove 22, the slide tray 20 is fixed to the main body 30 is a state the slide tray 20 is fully drawn out from the main body 30. The slide tray 20 can take a position of drawing out from the main body 30 at four stages, between the state shown in FIG. 11A and the state shown in FIG. 11B.

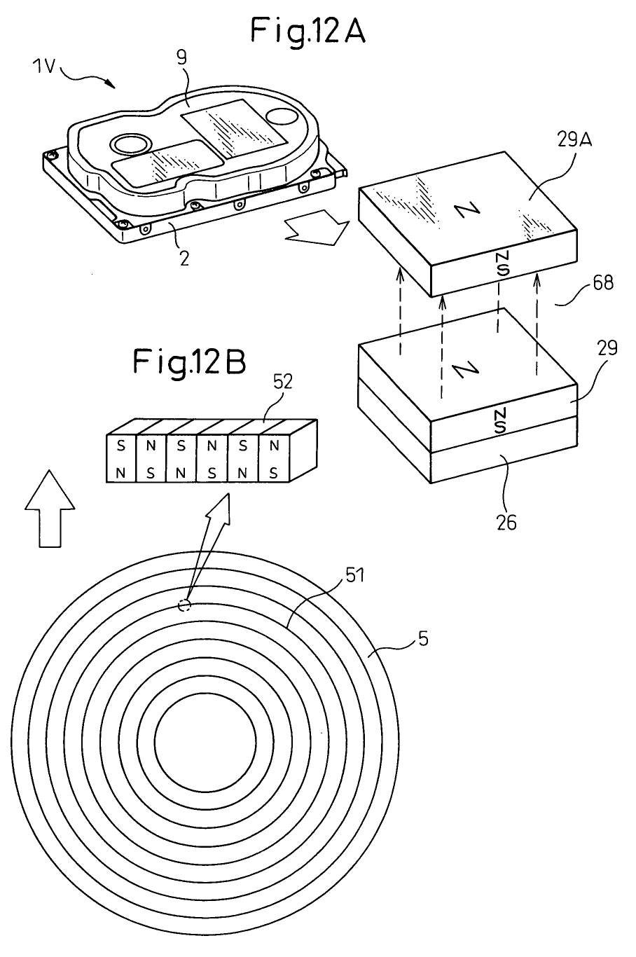

FIG. 12A explains the principle of erasing data recorded on the magnetic disk by the vertical recording system, by the data erasing device according to the present invention. FIG. 12A shows the magnetic flux direction of the magnets 29 and 29A. According to the present embodiment, the magnet 29 is disposed on the yoke 26 such that the upper side of the magnet 29 is an N pole, and the lower side of the magnet 29 is an S pole. The magnet 29A is disposed such that the upper side of the magnet 29 is an N pole, and the lower side of the magnet 29 is an S pole via the path 68. The magnets 29 and 29A are disposed to face each other via the path 68 in mutually adsorbing polarities, and the magnetic flux generated from the N pole of the magnet 29 is directed toward the S pole of the magnet 29A. In other words, the magnetic field is generated from the magnet 29 toward the magnet 29A. The magnets 29 and 29A function as magnetic field generating means.

On the other hand, because the data is recorded on the magnetic disk 5 by the vertical recording system, magnetic particles 52 on one track 51 are magnetized in a direction perpendicular to the flat surface of the magnetic disk 5, as shown in FIG. 12B. Therefore, in order to erase the data recorded on the magnetic disk 5, it is desirable to use the magnetic field in a direction perpendicular to the magnetic disk 5. Accordingly, in the present invention, as shown in FIG. 12A, in order to erase the data recorded on the magnetic disk 5 within the magnetic disk device 1V, the magnetic disk device 1V is arranged to move in the magnetic field generated by the magnets 29 and 29A. With this arrangement, the data recorded on the magnetic disk 5 can be erased using the component in the perpendicular direction in the area of the magnetic field generated by the magnets 29 and 29A. A magnet of the Nd—Fe—B system having a high magnetic flux density like the magnets 27 and 28 can be used for the magnets 29 and 29A. A yoke can be provided at the N pole side of the magnet 29A.

As explained above, according to the present embodiment, data recorded by the vertical recording system on the magnetic disk 5 provided within the cover 9 of the magnetic disk device 1V shown in FIG. 1 is erased using the magnetic field obtained based on the layout of the magnets 29 and 29A. In order to bring the magnetic field into contact with the whole surface of the magnetic disk 5, the sizes of the magnets 29 and 29A are made small, as described above. At the same time, in order to bring the magnetic field from the magnets 29 and 29A into contact with the whole surface of the magnetic disk 5, a relative move is generated between the magnets 29 and 29A. In other words, the magnet 29 is moved in the forward and backward directions (Y direction) on the data erasing device 50 with the slide tray 20, and the magnetic disk 5 and the magnet 29A are moved in approximately the left and right directions (X direction) from the magnet 29 with the swing tray 40, thereby realizing the bringing of the magnetic field into contact with the whole surface of the magnetic disk 5.

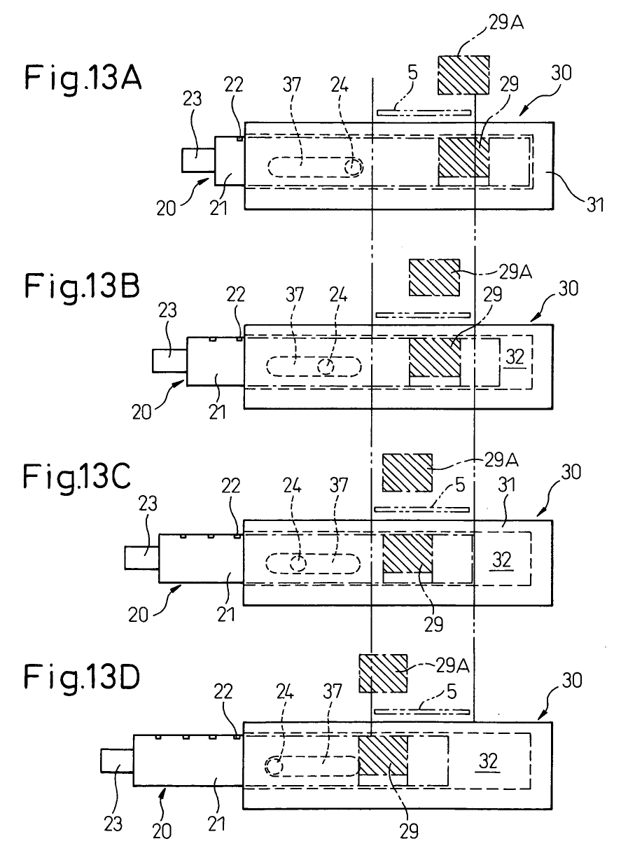

A method of completely erasing data recorded by the vertical recording system on the magnetic disk 5 within the magnetic disk device 1V, with the data erasing device 50 according to the second embodiment of the present invention is explained with reference to FIG. 8, FIG. 13, and FIG. 14. The relationship between the position of the magnet 29 on the slide tray 20 and the position of the magnetic disk 5 when the magnetic disk device 1V and the magnet 29A are fitted to the swing tray 40 is the same as the relationship when the horizontal recording system explained with reference to FIG. 8A is employed. Therefore, this explanation is simplified.

FIG. 8A is a top plan view of the data erasing device 50 in a state shown in FIG. 11A. This shows a relationship between the position of the magnet 29 accommodated in the slide tray 20 and the position of the magnetic disk 5 when the magnetic disk device 1V and the magnet 29A are fitted to the swing tray 40. FIG. 13A shows a state that the data erasing device 50 shown in FIG. 8A is looked at from the side surface. According to the second embodiment, as shown in FIG. 13A, the magnets 29 and 29A are disposed in the slide tray 20 and the magnetic tray not shown so that the magnetic flux generated by the magnets 29 and 29A is within the range of a quarter of the diameter of the magnetic disk 5 within the magnetic disk device 1V.

When the swing tray 40 is swung from the position of a solid line to the position of a broken line as shown in FIG. 8B, the magnetic disk 5 and the magnet 29A move in approximately the left and right directions above the magnet 29 as shown by a chain double-dashed line. A relative moving area of the magnet 29 observed from the magnetic disk 5 is shown as the area (a) in FIG. 14. As is clear from FIG. 14, when the swing tray 40 is swung in the state shown in FIG. 13A, the magnets 29 and 29A can erase the data vertically recorded in the area (a) of the magnetic disk 5 corresponding to one quarter of the diameter of the magnetic disk 5.

Next, in the state shown in FIG. 13A, the relationship between the latch lever 34 (refer to FIG. 11) and the groove 22 is changed to a state shown in FIG. 13B, and the slide tray 20 is fixed with the latch lever 34. In this state, the magnetic flux of the magnets 29 and 29A is positioned within a range of one quarter of the diameter of the magnetic disk 5 from the center of the magnetic disk 5 toward the rear end of the magnetic disk 5. In this state, the swing tray 40 is oscillated as described above. A relative moving area of the magnet 29 observed from the magnetic disk 5 is shown as the area (b) in FIG. 14. As is clear from FIG. 14, when the swing tray 40 is swung in the state shown in FIG. 13B, the magnets 29 and 29A can erase the data vertically recorded in the area (b) of the magnetic disk 5 corresponding to one quarter of the diameter of the magnetic disk 5, adjacent to the data area of the magnetic disk 5 erased in the state shown in FIG. 13A.

Next, in the state shown in FIG. 13B, the groove 22 is shifted by one to obtain a state shown in FIG. 13C, and the slide tray 20 is fixed with the latch lever 34. In this state, the magnetic flux of the magnets 29 and 29A is positioned within a range of one quarter of the diameter of the magnetic disk 5 from the center of the magnetic disk 5 toward the front end of the magnetic disk 5. In this state, the swing tray 40 is oscillated as described above. A relative moving area of the magnet 29 observed from the magnetic disk 5 is shown as the area (c) in FIG. 14. As is clear from FIG. 14, when the swing tray 40 is swung in the state shown in FIG. 13C, the magnets 29 and 29A can erase the data vertically recorded in the area (c) of the magnetic disk 5 corresponding to one quarter of the diameter of the magnetic disk 5, adjacent to the data area of the magnetic disk 5 erased in the state shown in FIG. 13B.

Last, in the state shown in FIG. 13C, the groove 22 is further shifted by one to obtain a state shown in FIG. 13D. In this state, the magnetic flux of the magnets 29 and 29A is positioned within a range of one quarter of the diameter of the magnetic disk 5 from the front end of the magnetic disk 5. In this state, the swing tray 40 is oscillated as described above. A relative moving area of the magnet 29 observed from the magnetic disk 5 is shown as the area (d) in FIG. 14. As is clear from FIG. 14, the magnets 29 and 29A can erase the data vertically recorded in the area (d) of the magnetic disk 5 corresponding to one quarter of the diameter of the magnetic disk 5, adjacent to the data area of the magnetic disk 5 erased in the state shown in FIG. 9C.

As described above, according to the data erasing device 50 of the second embodiment, the magnets are replaced and the magnetic tray added, and the slide tray 20 is drawn out at four stages from the case 31 of the main body 30. The slide tray 40 is oscillated at each stage. With this arrangement, the data vertically recorded on the whole surface of the magnetic disk 5 can be erased with the small-sized magnets 29 and 29A having a size of about a quarter of that of the magnetic disk 5.

According to the data erasing device of the second embodiment, in the case of erasing data of the magnetic disk device 1H on which data is recorded by the horizontal recording system, the magnets 27 and 28 are mounted on the slide tray as shown in FIG. 14. The magnet tray 80 is fitted to the top of the swing tray 40 that accommodates the magnetic disk device 1H, with the long axel pin 44L. The magnets 27 and 28 are adhered mutually oppositely upside down to the magnet accommodation hole 82 of the magnet tray 80. A magnet like the magnet 29A having projections is fitted. When the operation based on the same data erasing method as that described above is carried out, the data can be reliably erased without turning the magnetic disk device 1H accommodated in the swing tray 40 upside down.

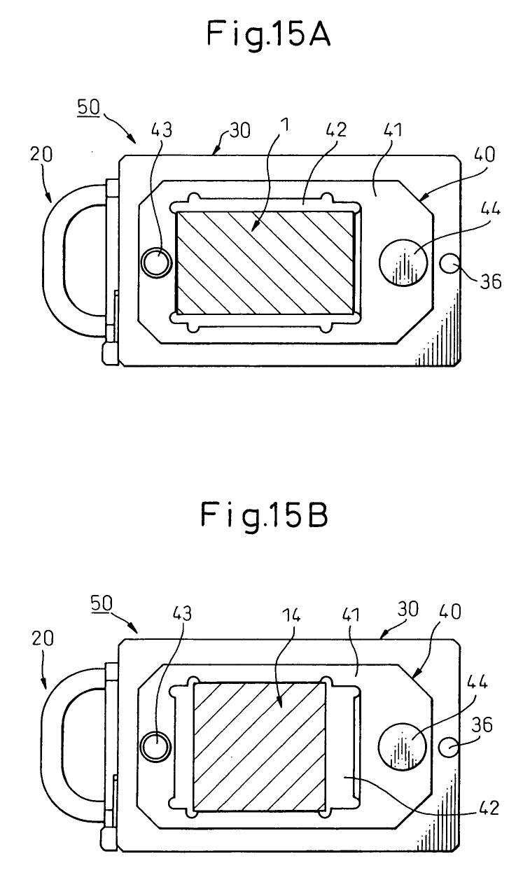

As explained above, the data erasing device 50 according to the second embodiment accommodates the magnetic disk device 1 in the medium accommodation hole 42 in the longitudinal direction of the swing tray 40, as shown in FIG. 15A. The data recorded on the magnetic disk accommodated in this magnetic disk device 1 is erased. At the same time, the data erasing device 50 according to the second embodiment is arranged such that the medium accommodation hole 42 can accommodate a separate recording medium, for example, a magnetic tape cartridge 14 as the magnetic recording medium used in the library device, in the short side direction of the medium accommodation hole 42 (refer to FIG. 15B). As explained above, the data erasing device 50 according to the present invention can erase data recorded horizontally and data recorded vertically on plural kinds of magnetic recording mediums, by changing the device structure to meet the shapes of the medium accommodation hole 42 formed on the swing tray 40. Further, the pin 44 of the data erasing device 50 according to the present invention is extracted from the main body 30, and the swing tray 40 can be replaced corresponding to the magnetic recording medium. With this arrangement, the data erasing device 50 according to the present invention can be used to erase data recorded on more kinds of magnetic recording mediums.

In the above embodiments, the magnetic disk device (a hard disk device) 1 and the magnetic tape cartridge 14 are explained as magnetic recording mediums from which data is erased by the data erasing devices 50 and 60. However, the magnetic recording mediums from which data is erased by the data erasing devices 50 and 60 according to the present invention are not particularly limited.

What is claimed is:

1. A data erasing device that erases data recorded on a magnetic recording medium, using a magnetic field generated from permanent magnets each having an N pole and an S pole, the data erasing device comprising:
a main body case that has an opening formed on at least one side surface, and has a path provided inside the main body to continue to the opening;
a first magnetic field generating source that is provided along one surface of the path, with at least three permanent magnets adjacently disposed in mutually adsorbing polarities;
a second magnetic field generating source that is provided opposite to the first magnetic field generating source, on other surface of the path; and
a tray capable of accommodating the magnetic recording medium, and having a size allowing the tray to be able to reciprocate within the main body case along the path, wherein
the second magnetic field generating source consists of at least three permanent magnets that face the permanent magnets of the first magnetic field generating source, respectively, at least one set of mutually opposite permanent magnets are disposed such that magnetic field lines are generated in a direction perpendicular to the path, and the rest of the sets of permanent magnets are disposed such that magnetic field lines are generated in a direction along the path.

2. The data erasing device according to claim 1, wherein
the permanent magnets in the first magnetic field generating source and the permanent magnets in the second magnetic field generating source are disposed on a ferromagnetic plate, respectively.

3. The data erasing device according to claim 1, wherein
the number of the permanent magnets in the first magnetic field generating source and the number of the permanent magnets in the second magnetic field generating source are three, respectively.

4. The data erasing device according to claim 3, wherein
polarities at the path side of the three permanent magnets in the first magnetic field generating source are in the order of an N pole, an S pole, and an N pole from the opening side, and polarities at the path side of the three permanent magnets in the second magnetic field generating source are in the order of an N pole, an S pole, and an S pole from the opening side.

5. A data erasing device that erases data recorded on a magnetic recording medium, by using a magnetic field generated from permanent magnets each having an N pole and an S pole, the data erasing device comprising:
a main body case for holding the magnetic recording medium on an upper surface;
a first magnetic field generating source consisting of two permanent magnets adjacently disposed in mutually adsorbing polarities;
a second magnetic field generating source consisting of one permanent magnet, having the same size as that of the first magnetic field generating source, and having polarities in up and down directions;
a third magnetic field generating source consisting of one permanent magnet, having the same size as that of the second magnetic field generating source, and having the same polarities as those of the second magnetic field generating source;
a first moving member on which the first and the second magnetic field generating sources can be mounted replaceably, and on which the mounted magnetic field generating source can be moved to a predetermined direction within the main body case;
a second moving member in which the magnetic recording medium can be moved in a direction approximately orthogonal to a moving direction of the magnetic field generating source, on the upper surface of the main body case; and
a holding member of the third magnetic field generating source, that is fitted to an upper part of the second moving member when the second magnetic field generating source is mounted on the first moving member, and that can have the third magnetic field generating source mounted at a position opposite to the second magnetic field generating source mounted on the first moving member.

6. The data erasing device according to claim 5, wherein
the first and the second magnetic field generating sources are fitted to a ferromagnetic plate such that a generated magnetic field passes the upper surface of the main body case and reaches the upper space,
the first moving member is fitted to the main body case so as to be moveable stepwise to the main body case such that the magnetic field is applied uniformly within a predetermined range on the upper surface of the main body case,
the second moving member includes a frame unit capable of accommodating the magnetic recording medium at the center in a state that the magnetic recording medium is held on the upper surface of the main body case, with one end of the frame unit rotatably fixed to the upper surface of the main body case with a rotation axis,
the holding member of the third magnetic field generating source has a positioning unit of the third magnetic field generating source that moves stepwise the third magnetic field generating source corresponding to the stepwise move of the first moving member, and
the second moving member is oscillated around the rotation axis in a state that the magnetic recording medium is accommodated in the frame unit, the position of the first moving member is sequentially changed stepwise, after the second moving member is oscillated by a predetermined number of times, and when the second magnetic field generating source is mounted on the first moving member, the third magnetic field generating source is moved with the holding member corresponding to the stepwise move of the first moving member, thereby making it possible to oscillate the second moving member by a predetermined number of times at each stage.

7. The data erasing device according to claim 6, wherein
a grip that facilitates the oscillation of the frame unit is provided in projection at an end of the frame unit opposite to the end at which the rotation axis is provided, and
a concavity for receiving the grip is provided at one end of the frame constituting the holding member of the third magnetic field generating source, and a through-hole for passing through the rotation axis can be provided at the other end.

8. The data erasing device according to claim 6, wherein
a knob which facilitates a move of the first moving member is provided at the furthest end of the first moving member from the main body case.

9. The data erasing device according to claim 6, wherein
grooves are formed at a predetermined interval on the upper surface of the first moving member, and a latch lever that latches a movement of the first moving member is provided in engagement with the grooves on the main body case.

10. The data erasing device according to claim 6, wherein
a stopper protrusion is provided on a side surface of the first moving member, and a guide groove that receives the stopper protrusion and prescribes a moving range of the first moving member is provided on the inner surface of the main body case.

11. The data erasing device according to claim 6, wherein
a length of a magnetic flux maximum area of the permanent magnets is smaller than a length of a data erasing range of the magnetic recording medium accommodated within the frame unit, and the number and the interval of the grooves are determined according to the length of the magnetic flux maximum area of the permanent magnets and the length of the data erasing range of the magnetic recording medium.

12. The data erasing device according to claim 11, wherein
the magnetic recording medium is a magnetic disk device, the length of the magnetic flux maximum area of the permanent magnets is set to one quarter of a diameter of the magnetic disk accommodated in the magnetic disk device, the number of the grooves is four, and the interval between the grooves is equal to the length of the magnetic flux maximum area of the permanent magnets.

13. The data erasing device according to claim 6, wherein
a stopper for prescribing an oscillation range of the second moving member is provided on the upper surface of the main body case.

14. The data erasing device according to claim 6, wherein
a medium accommodation hole provided at the center of the frame unit to accommodate the magnetic recording medium has a shape that permits the accommodation of a plurality of kinds of magnetic recording mediums.

15. The data erasing device according to claim 6, wherein
the frame unit can be replaced with another frame unit having a different shape of a medium accommodation hole to accommodate another magnetic recording medium.
